(19) United States
(12) Patent Application Publication
(10) Pub. No.: US 2015/0350894 A1
(43) Pub. Date: Dec. 3, 2015

(54) Method and System for Establishing a Secure Communication Channel

(71) Applicant: Entersekt, LLC, Atlanta, GA (US)

(72) Inventor: Christiaan Johannes Petrus Brand, Stellenbosch (ZA)

(73) Assignee: Entersekt, LLC, Atlanta, GA (US)

(21) Appl. No.: 14/289,692

(22) Filed: May 29, 2014

(51) Int. Cl. H04W 12/04; H04L 29/06

(52) U.S. Cl. CPC H04W 12/04; H04L 63/0435; H04L 63/0442

(57) ABSTRACT

A method and system for establishing a secure communication channel is disclosed. A remotely accessible server updates a used counter value to yield an updated counter value. The used counter value was used to generate a previously used symmetric key for encrypting communications between the server and a mobile handset. The updated counter value is used to generate a symmetric key, which is included in a key transfer message. The key transfer message is asymmetrically encrypted using a handset public key and transmitted to the handset such that it is capable of using a handset private key to decrypt the key transfer message and obtain the symmetric key. Further data received from the handset is decrypted asymmetrically using a server private key and symmetrically using the symmetric key, and further data communicated to the handset is encrypted symmetrically using the symmetric key and asymmetrically using the handset public key.

### FIELD OF THE INVENTION

This invention relates to methods and systems for secure communications, and, more particularly, to a method and system for establishing a secure communication channel between a mobile handset and a remotely accessible server.

### BACKGROUND TO THE INVENTION

It is often desirable to establish a secure communication channel between two communicating parties, particularly in cases where sensitive data is to be transmitted between the parties. Many systems exist wherein a secure communication channel is required between a mobile handset and a remotely accessible server, such as an application server, so as to ensure that data communicated between the parties are transmitted in a manner that is end-to-end secure.

In the remainder of this specification the term “mobile handset” should be interpreted to include any mobile communications device capable of communicating over a communications network, such as a cellular network, and having at least a limited amount of processing power. The term should be interpreted to specifically include all mobile or cellular phones but may also include portable computers such as laptops, handheld personal computers and the like.

An increasing number of financial transactions are initiated, conducted and/or authorized using mobile handsets. Accordingly, secure communication channels are often required when sensitive data relating to such financial transactions are to be transmitted to and from the mobile handset.

Miscreants are constantly developing new techniques to intercept user and transactional data and to use these for defrauding one or more parties involved. Examples of security threats include Man-In-The-Middle (MITM) attacks, Pharming, Phishing, Over-The-Air SMS/data sniffing, third party infrastructure hijacking, Trojans, key loggers as well as various combinations of these and other threats. Using these and other methods, sensitive data such as financial information or encryption keys associated with a user or the mobile handset of the user may be obtained and used for fraudulent purposes.

A known method used in an attempt to alleviate the problems described above, is the generation of credentials having a limited validity, typically for a single use. For example, a single-use encryption key or password may be generated for securing a communication channel between a mobile handset and a remotely accessible server.

The mobile handset may be required to produce the appropriate key or password using information contained in a challenge from the remotely accessible server. For example, the remotely accessible server may transmit a challenge that includes a seed value to the mobile handset. The mobile handset uses the seed value and an incremental counter value to generate a single-use key or password for a particular communication, which can be verified by the remotely accessible server.

A problem associated with this method of securing a communication channel is that it may involve both the mobile handset and the remotely accessible server being required to possess the seed value and/or the counter value at some stage. If the mobile handset is compromised, these values may be obtained and fraudulently used, as described above.

Methods exist whereby keys or other sensitive data such as a seed and/or counter value are encrypted with a passcode and stored on the mobile handset in an encrypted format. However, the encrypted data may not be securely stored, and it may be possible that the passcode is obtained, for example by way of an exhaustive search, in order to decrypt and obtain the keys or other sensitive data.

Embodiments of the present invention aim to address these and other problems, at least to some extent.

### SUMMARY OF THE INVENTION

In accordance with the invention there is provided a method of establishing a secure communication channel between a mobile handset and a remotely accessible server, the method being carried out at the remotely accessible server and comprising the steps of: deterministically updating a used counter value to yield an updated counter value, the used counter value having been used to generate a previously used symmetric key for encrypting communications between the remotely accessible server and the mobile handset; storing the updated counter value; using the updated counter value to generate a symmetric key; generating a key transfer message including the symmetric key generated using the updated counter value; asymmetrically encrypting the key transfer message using a handset public key associated with the mobile handset; transmitting the key transfer message to the mobile handset such that the mobile handset is capable of using a handset private key corresponding to the handset public key to decrypt the key transfer message and obtain the symmetric key; decrypting further data received from the mobile handset asymmetrically using a server private key associated with the remotely accessible server and symmetrically using the symmetric key; and encrypting further data communicated to the mobile handset symmetrically using the symmetric key and asymmetrically using the handset public key.

Further features of the invention provide for the step of deterministically updating the used counter value to be triggered by one or both of a mobile handset initiation event and a server initiation event; for the symmetric key generated using the updated counter value to be used for encryption and decryption of further data until a mobile handset initiation event or server initiation event occurs; for the mobile handset initiation event or the server initiation event to include an asymmetric cryptographic operation performed on data communicated between the remotely accessible server and the mobile handset; alternatively, for the mobile handset initiation event to include any communication transmitted from the mobile handset to the remotely accessible server; and for the server initiation event to include any communication transmitted from the remotely accessible server to the mobile handset.

Yet further features of the invention provide for the mobile handset initiation event to include one or more of: receiving a communication from the mobile handset which is encrypted asymmetrically using the server public key, receiving a communication from the mobile handset which is digitally signed using the handset private key, and receiving a communication from the mobile handset which is encrypted symmetrically using the previously used symmetric key; and for the server initiation event to include one or more of: one or more handshake steps between the remotely accessible server and the mobile handset, transmitting a communication to the mobile handset which is encrypted asymmetrically using the handset public key, and transmitting a communication to the mobile handset which is encrypted symmetrically using the previously used symmetric key.

Still further features of the invention provide for the used counter value to have been used together with a static seed value to generate the previously used symmetric key; for the step of using the updated counter value to generate a symmetric key to include using the updated counter value together with the static seed value; and for the step of deterministically updating the used counter value to be preceded by one or more handshake steps carried out between the remotely accessible server and the mobile handset.

Further features of the invention provide for the one or more handshake steps to include one or both of: receiving a digital user certificate from the mobile handset using a server software application installed on the remotely accessible server and validating the digital user certificate by utilizing functionality provided by an encryption module distributed by a certificate authority, the digital user certificate having been issued to the mobile handset by the certificate authority and including the handset public key and an identifier uniquely associated with the mobile handset; and transmitting a digital server certificate to the mobile handset for validation of the remotely accessible server, validation of the digital server certificate being conducted using a handset software application installed on the mobile handset utilizing functionality provided by an encryption module provided by the certificate authority, the digital server certificate having been issued to the remotely accessible server by the certificate authority and including the server public key corresponding to the server private key.

Yet features of the invention provide for the key transfer message to be an acknowledgement message transmitted to the mobile handset in response to a mobile handset initiation event; alternatively, for the key transfer message to be transmitted to the mobile handset as part of an asymmetrically encrypted payload; and for the method to include the step of: if symmetric decryption of further data using the symmetric key is unsuccessful, attempting to decrypt the further data using the previously used symmetric key generated using the used counter value instead of using the symmetric key generated using the updated counter value, thereby accounting for the possibility of the key transfer message not being successfully transmitted to or obtained at the mobile handset.

A further feature of the invention provides for the method to include the step of: in response to determining that the previously used symmetric key or a symmetric key used or generated prior to the previously used symmetric key was used to encrypt data received from the mobile handset instead of using the symmetric key generated using the updated counter value, associating the mobile handset with a potential security threat.

Further features of the invention provide for one or both of the static seed value and the counter value to be unknown to the mobile handset; for the symmetric key to be generated using a one-time password algorithm, wherein the counter value and the static seed value are respectively used as a counter and a key in the algorithm; and for the one-time password algorithm to be Initiative For Open Authentication (OATH) HOTP.

The invention extends to a system for establishing a secure communication channel between a mobile handset and a remotely accessible server, the system comprising: a handset software application configured to be installed on a mobile handset to receive a key transfer message and asymmetrically decrypt the key transfer message to obtain a symmetric key therefrom, the mobile handset having associated therewith a handset public key and a corresponding handset private key; and a remotely accessible server including: an asymmetric cryptographic component for performing asymmetric encryption and decryption; a symmetric cryptographic component for performing symmetric encryption and decryption; a counter updating component for deterministically updating a used counter value to yield an updated counter value, the used counter value having been used to generate a previously used symmetric key for encrypting communications between the remotely accessible server and the mobile handset; a storing component for storing the updated counter value; a key generating component for using the updated counter value to generate a symmetric key; a message generating component for generating a key transfer message including the symmetric key generated using the updated counter value; a data transmitting component for transmitting data to the mobile handset; and a data receiving component for receiving data from the mobile handset, wherein the remotely accessible server is configured to: asymmetrically encrypt the key transfer message using the handset public key; transmit the key transfer message to the mobile handset such that the mobile handset is capable of using the handset private key corresponding to the handset public key to decrypt the key transfer message and obtain the symmetric key; decrypt further data received from the mobile handset asymmetrically using a server private key associated with the remotely accessible server and symmetrically using the symmetric key; and encrypt further data communicated to the mobile handset symmetrically using the symmetric key and asymmetrically using the handset public key.

Further features of the invention provide for the remotely accessible server to further include a triggering component for triggering deterministic updating of a used counter value; and for deterministic updating of a used counter value to be triggered by one or both of a mobile handset initiation event and a server initiation event.

A yet further feature of the invention provides for the handset software application to include a server validation component for validating a digital server certificate transmitted from the remotely accessible server to the mobile handset, validation of the digital server certificate being conducted utilizing functionality provided by an encryption module provided by a certificate authority, the digital server certificate having been issued to the remotely accessible server by the certificate authority and including the server public key corresponding to the server private key.

A still further feature of the invention provides for the remotely accessible server to include a handset validation component for validating a digital user certificate transmitted from the mobile handset to the remotely accessible server, validation of the digital user certificate being conducted utilizing functionality provided by an encryption module distributed by a certificate authority, the digital user certificate having been issued to the mobile handset by the certificate authority and including the handset public key and an identifier uniquely associated with the mobile handset.

The invention further extends to a computer program product for establishing a secure communication channel between a mobile handset and a remotely accessible server, the computer program product comprising a computer-readable medium having stored computer-readable program code for performing the steps of: deterministically updating a used counter value to yield an updated counter value, the used counter value having been used to generate a previously used symmetric key for encrypting communications between the remotely accessible server and the mobile handset; storing the updated counter value; using the updated counter value to generate a symmetric key; generating a key transfer message including the symmetric key generated using the updated counter value; asymmetrically encrypting the key transfer message using a handset public key associated with the mobile handset; transmitting the key transfer message to the mobile handset such that the mobile handset is capable of using a handset private key corresponding to the handset public key to decrypt the key transfer message and obtain the symmetric key; decrypting further data received from the mobile handset asymmetrically using a server private key associated with the remotely accessible server and symmetrically using the symmetric key; and encrypting further data communicated to the mobile handset symmetrically using the symmetric key and asymmetrically using the handset public key, wherein the computer-readable medium is a non-transitory computer-readable medium, the computer-readable program code being executable by a processing circuit.

In order for the invention to be more fully understood, implementations thereof will now be described with reference to the accompanying drawings.

### BRIEF DESCRIPTION OF THE DRAWINGS

In the drawings:

FIG. 1A is a schematic illustration of an embodiment of a system for establishing a secure communication channel between a mobile handset and a remotely accessible server according to the invention;

FIG. 1B is a block diagram illustrating components of a remotely accessible server according to embodiments of the invention;

FIG. 1C is a block diagram illustrating components of a handset software application according to embodiments of the invention;

FIG. 1D illustrates an exemplary digital certificate that may be used in embodiments of the invention;

FIG. 2 is a flow diagram illustrating a method of establishing a secure communication channel according to embodiments of the invention; and

FIG. 3 is a swim-lane flow diagram illustrating a method of establishing a secure communication channel according to embodiments of the invention.

### DETAILED DESCRIPTION WITH REFERENCE TO THE DRAWINGS

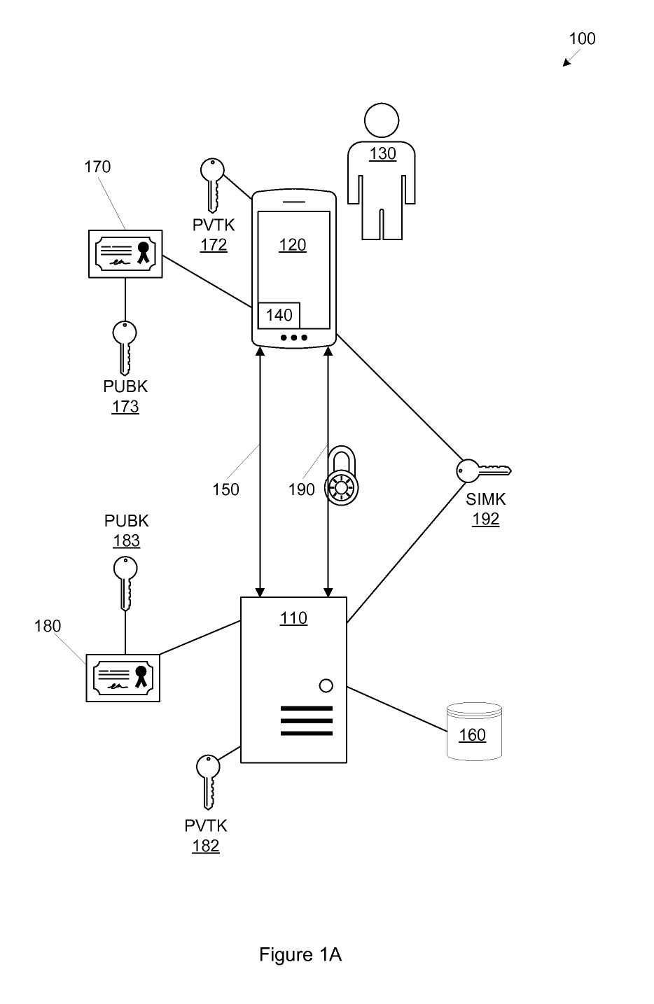

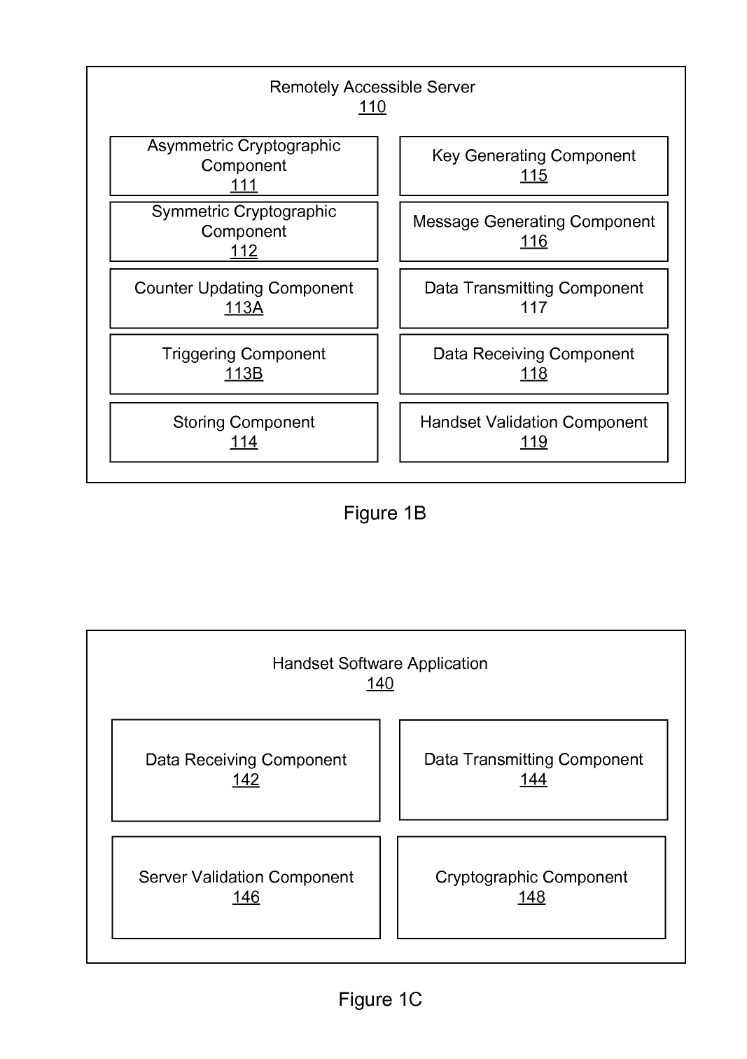

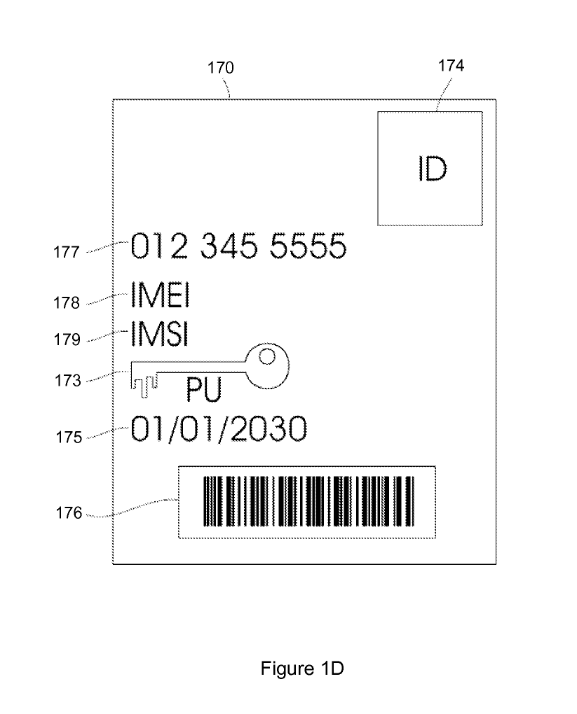

An embodiment of a system (100) for establishing a secure communication channel according to the invention is illustrated in FIG. 1A. The system (100) comprises a remotely accessible server (110) and a mobile handset (120) of a user (130). The mobile handset (120) has a handset software application (140) installed thereon. In this embodiment, the remotely accessible server (110) is an application server and the mobile handset (120) is a mobile phone.

The remotely accessible server (110) and mobile handset (120) are able to communicate over a communication channel (150). The remotely accessible server (110) has or is linked to a database (160) on which details relating to the mobile handset (120) and/or the user (130) may be stored.

An encryption module may be provided by a certificate authority (not shown) which provides encryption functionality to the remotely accessible server (110) and/or the mobile handset (120). It should be apparent that the encryption modules may be compiled as part of the handset software application (140) and a server software application resident on the remotely accessible server (110), respectively. Where in the remainder of this description reference is made to functionality of either the server software application or the handset software application (140) it will be appreciated that such functionality may in effect be provided by the encryption module at the server or the mobile handset or vice versa.

The certificate authority may be managed or provided by the same entity managing or providing the remotely accessible server (110), or may be an independent or external certificate authority.

In this embodiment, both the remotely accessible server (110) and the mobile handset (120) have been provided with a digital certificate by the certificate authority. The mobile handset has a digital user certificate (170), while the remotely accessible server (110) has a digital server certificate (180), as shown in FIG. 1A.

A user private (172) and public (173) cryptographic key pair is associated with the mobile handset (120), and a server private (182) and public (183) cryptographic key pair is associated with the remotely accessible server (110).

As shown in FIG. 1B, an embodiment of the remotely accessible server (110) may include one or more of an asymmetric cryptographic component (111) for performing asymmetric encryption and decryption, a symmetric cryptographic component (112) for performing symmetric encryption and decryption, a counter updating component (113A), a triggering component (113B), a storing component (114), a key generating component (115), a message generating component (116), a data transmitting component (117), a data receiving component (118), and a handset validation component (119).

As illustrated in FIG. 1C, an embodiment of the handset software application (140) may include one or more of a data receiving component (142), a data transmitting component (144), a server validation component (146), and a cryptographic component (148) for performing asymmetric and/or symmetric encryption and decryption.

The user key pair (172, 173) may be calculated by the certificate authority and provided to the mobile handset (120). This will mainly happen in cases where the handset (120) itself does not have enough processing power to calculate the key pair itself. The user key pair (172, 173) may also be calculated at the handset (120) itself.

The user private key (172) may typically be sent to the mobile handset (120) over a secure channel, while the associated user public key (173) may be included in the digital user certificate (170) and be transmitted to the handset (120) separately. In some embodiments, after a key pair is generated, either by the mobile handset (120) or at a remote entity which transmits the key pair to the mobile handset (120), a certificate signing request is transmitted to the certificate authority for signature.

An exemplary digital user certificate (170) is illustrated in FIG. 1D. In addition to the user public key (173) and a certificate authority signature (176), the certificate (170) may also contain an identifier (174) which is uniquely associated with the mobile handset (120). The identifier (174) may be any unique key which is issued by the certificate authority. In the current embodiment of the invention, the identifier (174) is a sequential number generated by the certificate authority. It should be appreciated that due to the sequential nature of the identifier (174), a one-to-one relationship exists between each certificate issued by the certificate authority and a mobile handset. In addition to the above, the certificate (170) may also include other information such as, for example, a mobile phone number (177) associated with a Subscriber Identity Module (SIM) card of the handset (120), the handset's International Mobile Station Equipment Identity (IMEI) (178) and/or International Mobile Subscriber Identity (IMSI) (179) numbers as well as a certificate expiry date (175).

The format of the digital server certificate (180) may be similar to that of the digital user certificate (170) and includes the server public key (183). The corresponding server private key (182) is typically saved in a secure location in the remotely accessible server (110).

Each time the mobile handset (120) and the remotely accessible server (110) initiate communications between them, it will start a certificate exchange process, whereby the digital user certificate (170) is sent to the server (110), and the digital server certificate (180) is sent to the handset (120). Both parties will then validate the content of the received certificates (170, 180), and the digital signature, to make sure that the details in the certificates (170, 180) was not tampered with. This validation may be done by using a certificate authority digital certificate that is part of both the handset software application (140) and server application or the respective encryption modules. Knowledge of the certificate authority public key may, however, be sufficient to enable validation of the respective certificates to be conducted. It should be appreciated that the certificate authority digital certificate may include the certificate authority public key and that the user and server side applications will therefore use the certificate authority public key to decrypt the signed certificates (170, 180). If the certificates are not capable of being decrypted with the certificate authority public key, it will be apparent that they were not signed with the certificate authority private key, and are accordingly not authentic.

At this point, both parties can be sure they are talking to the intended recipients. It should be appreciated that, after the certificate exchange, the handset (120) will be in possession of the server public key (183) and the remotely accessible server (110) will be in possession of the handset public key (173).

The handset identifier (174) included in the digital user certificate (170) may also be used by the remotely accessible server (110) to uniquely identify the handset (120) and, accordingly, the user. The database (160) may include all the identifiers issued to clients, and the remotely accessible server (110) may choose to only communicate with handsets included in the database.

The digital user certificate (170) is therefore used not only to authenticate the communication channel (150) between the handset (120) and the remotely accessible server (110), but also to uniquely identify the handset (120) that is attempting to communicate with the remotely accessible server (110).

It should be appreciated that the handset software application (140) may also validate that the server (110) is the rightful owner of the certificate it sent, simply by virtue of the fact that the handset software application (140) is capable of decrypting communication sent to it by the server (110). Only communications encrypted with the server private key (182) will be capable of being decrypted with the server public key (183).

The remotely accessible server (110) further stores, in association with an identifier of the user (130) and/or the handset (120), a counter value and a static seed value. These values may typically be stored in the database (160). It being accepted of course that appropriate measures will be taken to protect the database and prevent unauthorised access to it.

The system (100) described above with reference to FIGS. 1A to 1D is usable in a method of establishing a secure communication channel (190) between the mobile handset (120) and the remotely accessible server (110) over which data is both asymmetrically encrypted using the user and server key pairs and symmetrically encrypted using a dynamic symmetric key (192), which will be described in greater detail below.

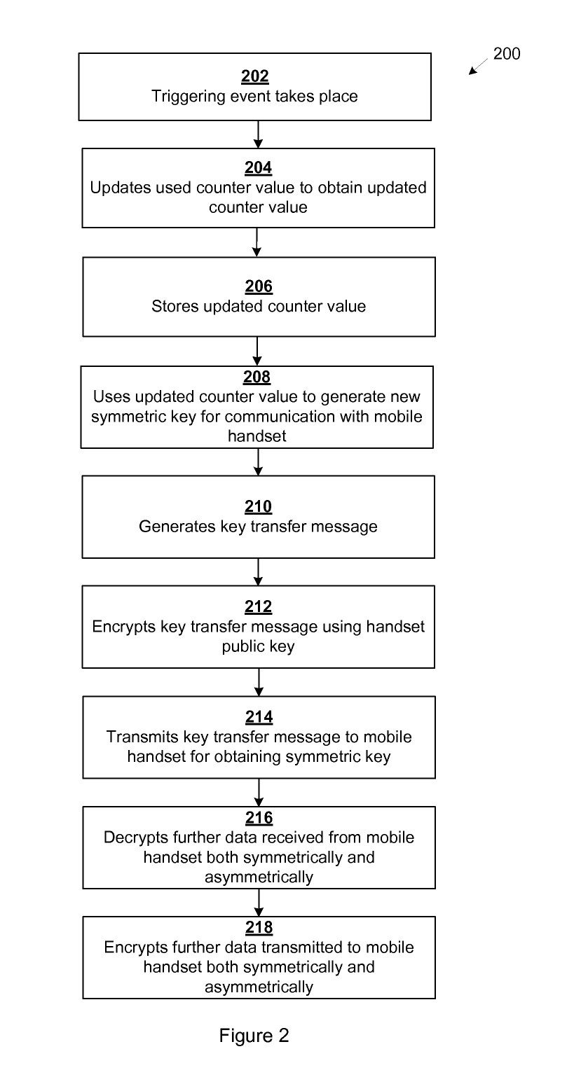

The flow diagram (200) of FIG. 2 illustrates steps conducted at the remotely accessible server (110) in a method of establishing a secure communication channel according to the invention.

At a first stage (202), and typically during or after one or more handshake steps such as the certificate exchange described above, a triggering event takes place. The triggering event may be either a mobile handset initiation event or a server initiation event.

In this embodiment, the triggering event is an asymmetric cryptographic operation performed on data communicated between the remotely accessible server (110) and the mobile handset (120). In other words, the mobile handset initiation event may for example occur when the remotely accessible server (110) receives a communication from the mobile handset (120) which is encrypted asymmetrically using the server public key (183), or when it receives a communication from the mobile handset (120) which is digitally signed using the handset private key (172), and the server initiation event may for example occur when the remotely accessible server (110) transmits a communication to the mobile handset (120) that is encrypted using the handset public key (173). The remotely accessible server (110) may be notified of the triggering event at its triggering component (113B).

The triggering event is not limited to asymmetric cryptographic operations. The triggering event may include the one or more handshake steps between the remotely accessible server (110) and the mobile handset (120). It may also be any communication transmitted from the mobile handset (120) to the remotely accessible server (110), or from the remotely accessible server (110) to the mobile handset (120). In some embodiments, the triggering event occurs when a communication transmitted from the mobile handset (120) to the remotely accessible server (110), or from the remotely accessible server (110) to the mobile handset (120), is encrypted using a previously used symmetric key calculated using a used counter value, as will be described in more detail below.

In some embodiments, the triggering event is the commencement of a new communication session between the mobile handset (120) and the remotely accessible server (110). The triggering event may also include a plurality or combination of the above.

The one or more handshake steps mentioned above may typically include the certificate exchange process. The remotely accessible server (110) therefore receives the digital user certificate (170) from the mobile handset using the server software application installed on the remotely accessible server (110) and validates the digital user certificate by utilizing functionality provided by the encryption module distributed by the certificate authority. The handset validation component (119) of the remotely accessible server (110) may be used for validating the digital user certificate (170). The encryption module provided by the certificate authority may be included in the handset validation component (119).

The remotely accessible server (110) also transmits the digital server certificate (180) to the mobile handset (120) for validation of the remotely accessible server (110), validation being conducted using the handset software application (140) installed on the mobile handset utilizing functionality provided by the encryption module provided by the certificate authority. The server validation component (146) may typically be used for validating the digital server certificate (180). The encryption module provided by the certificate authority may be included in the server validation component (146). Successful validation may, in some embodiments, be a triggering event.

The triggering event triggers the counter value to be updated. At a next stage (204), the remotely accessible server (110) then deterministically updates a used counter value to obtain an updated counter value. The used counter value was used to generate a previously used symmetric key for encrypting communications between the remotely accessible server (110) and the mobile handset (120). In this embodiment, the used counter value was used together with the static seed value to generate the previously used symmetric key. It should be appreciated that “deterministic” updating refers to updating the used counter value in any non-random manner, typically by way of incrementing the used counter value. The used counter value may be updated at the counter updating component (112).

At a next stage (206), the updated counter value is stored using the storing component (114). The updated counter value may be stored in the database (160) such that it is associated with the mobile handset (120) and/or the user (130). The remotely accessible server (110) then, at a next stage (208), uses the updated counter value to generate a new symmetric key (190) for communication with the mobile handset (120). The symmetric key (190) may be generated at the key generating component (115).

In this embodiment, the updated counter value is used together with the static seed value in a one-time password algorithm in order to generate the new symmetric key (190). An exemplary one-time password algorithm is Initiative For Open Authentication (OATH) HOTP. The counter value is, in such a case, used as the counter in the algorithm, while the static seed value is used as the key.

Both the seed value and counter value are known only to the remotely accessible server (110), and are therefore unknown to the mobile handset (120) and are never transmitted to the handset (120). Any other suitable algorithm may be used to generate the symmetric key, wherein at least a counter value of the algorithm is known only to the remotely accessible server (110) and not at the handset (120).

The static seed value typically remains the same for a particular handset. If communications are handset-initiated, the seed may start off having a “NULL” value. This means that no symmetric encryption or decryption is performed the first time the mobile handset communicates with the server. If communications are server-initiated, the seed may already have a value such that a symmetric key is calculated and included in the first asymmetrically encrypted payload transmitted to the mobile handset.

At a next stage (210), the remotely accessible server (110) generates a key transfer message at its message generating component (116), the key transfer message including the symmetric key (190) generated using the updated counter value. The key transfer message is then asymmetrically encrypted at a next stage (212), using the handset public key (173).

In the case where updating of the used counter value is triggered by a mobile handset initiation event such as the mobile handset (120) initiating a new communication session, the key transfer message is typically sent as an acknowledgement message to the mobile handset (120) in response to the mobile handset initiation event. In the case where updating of the used counter value is triggered by a server initiation event, the key transfer message may be transmitted to the mobile handset (120) as part of any asymmetrically encrypted payload to ensure that the mobile handset (120) receives the symmetric key (190) for use in subsequent communications.

The remotely accessible server (110) then, at a next stage (214), uses its data transmitting component (117) to transmit the key transfer message to the mobile handset (120) such that the mobile handset (120) is capable of using the handset private key (172) corresponding to the handset public key (173) to decrypt the key transfer message and obtain the symmetric key (190), typically using the cryptographic component (148) of its handset software application (140).

Once the mobile handset (120) has obtained the symmetric key (190), at a next stage (216), a secure communication channel (190) is established wherein data transmitted to the remotely accessible server (110), and typically received at its data receiving component (118), is decrypted both symmetrically by using both the symmetric key (190) and asymmetrically using the server private key (182).

Similarly, at a next stage (218), data transmitted over the secure communication channel (190) to the mobile handset (120) is then encrypted both symmetrically by using the symmetric key (190) and asymmetrically using the handset public key (183).

The symmetric key (190) is used for encryption until a further triggering event takes place, which again causes the counter value to be updated and a new symmetric key to be calculated, which is to be communicated to the mobile handset (120) as described above. In this embodiment, the symmetric key used is dynamic in that any cryptographic operation performed on data transmitted between the remotely accessible server (110) and the mobile handset (120) causes the symmetric key to be updated.

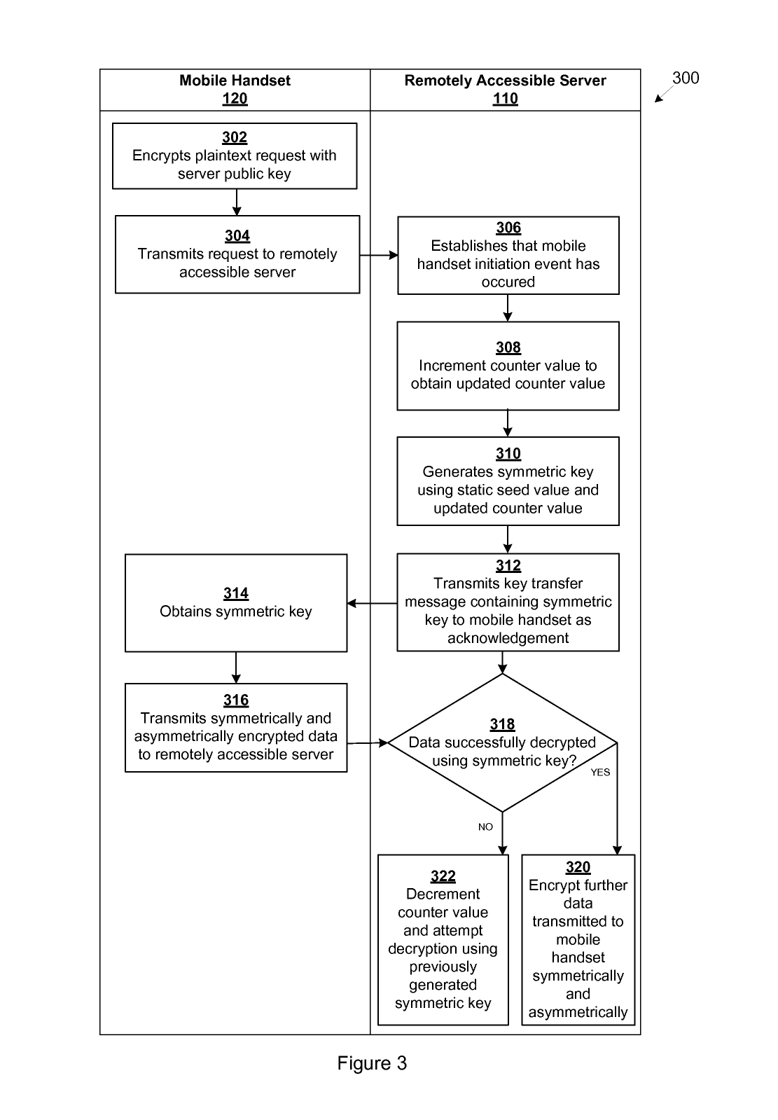

In the example illustrated by the swim-lane flow diagram (300) of FIG. 3, the mobile handset (120) initiates communication with the remotely accessible server (110).

At a first stage (302), the mobile handset (120) generates a plaintext request, for example a transaction request relating to a financial transaction or access to a financial account, and asymmetrically encrypts it using the server public key (183). This request is then transmitted to the remotely accessible server (110) over the channel (150) shown in FIG. 1, at a next stage (304). This may be preceded by the handshake steps described above in order for the server (110) and handset (120) to ensure they are communicating with the correct party.

The remotely accessible server (110), at a next stage (110), receives the request and determines that a mobile handset initiation event has occurred as a result of the asymmetric cryptographic operation performed by the mobile handset (120). In other embodiments, the mobile handset initiation event may, for example, be defined as the commencement of a new communication session between the parties.

At a next stage (308), the counter value is incremented to yield an updated counter value. It should be appreciated that updating of the counter value can also be triggered by the communication of data which is both symmetrically and asymmetrically encrypted, as the asymmetric encryption will prompt the remotely accessible server (110) to generate a new symmetric key for further symmetric encryption. Furthermore, updating of the counter value can be triggered by a digital signing operation performed by the mobile handset (120). The secure communication channel of the invention may also be used to securely transmit such signatures.

At a next stage (310), a new symmetric key is generated, preferably using the static seed value and updated counter value in a HMAC-based one-time password algorithm such as OATH HOTP or another one-time password algorithm. The remotely accessible server (110) then, at a next stage (312) transmits a key transfer message to the mobile handset (140), which it can receive at its data receiving component (142) and asymmetrically decrypt to obtain the generated symmetric key.

The mobile handset (140) can then, instead of only encrypting plaintext with the server public key (183), first encrypt the plaintext using the symmetric key in a symmetric algorithm such as Advanced Encryption Standard (AES)-128, and then further encrypt the symmetrically encrypted plaintext asymmetrically using the server public key (183) to yield the final ciphertext. The ciphertext is transmitted to the remotely accessible server (110) at a next stage (316).

At a next stage (318), the remotely accessible server (110) is thus required to first asymmetrically decrypt and then symmetrically decrypt the ciphertext received from the mobile handset (120). If encryption is successful, the remotely accessible server (110) proceeds as described above and typically also encrypts at least some further data it transmits to the mobile handset (140), firstly using the symmetric key, and also asymmetrically using the handset public key (173).

The remotely accessible server (110) may typically make use of one or more hardware security modules to perform asymmetric cryptographic operations. In such cases, data may simply be run through a symmetrical cipher before or after it is run through a hardware security module to enable successful cryptographic operations thereon.

The server (110) is configured to, if symmetric decryption of further data using the symmetric key is unsuccessful, at a next stage (322) attempt to decrypt the further data using the previously used symmetric key generated using the used counter value instead of using the symmetric key generated using the updated counter value, thereby accounting for the possibility of the key transfer message not being successfully transmitted to or obtained at the mobile handset. This may be the case when, for example, a packet of data containing the latest symmetric key did not successfully reach the mobile handset (120) over a particular wireless network.

In the case where updating of the counter value involves incrementing it, the server (110) will simply appropriately decrement the counter value and may also store the obtained counter value instead of the updated counter value.

It should be appreciated that although the system provided is described as including one remotely accessible server and one mobile handset, it is described as such primarily for illustrative purpose. The system may include a plurality of users each having a mobile handset in communication with the remotely accessible server. Each handset and/or user may then have a specific static seed value and/or counter value associated therewith at any given time, which is updated and stored by the server as herein described. There may also be a number of remotely accessible servers performing the functions described above. The system and method of the invention therefore enables multiple, distinct secure communication channels to be established between the server or servers and mobile handsets of users at any given time.

The term “handset software application” is not limited to a mobile software application and may include applications provided by a software development kit (SDK).

It is foreseeable that the certificate authority may periodically issue new certificates to all the handsets and/or servers to which it has previously issued certificates. This may be done as frequently as required, but preferably on an annual basis. The issuing of new user certificates may then also include the calculation and issuing of new user private/public key pairs in cases where the certificate authority calculated these on behalf of the mobile handset.

The above description is by way of example only and it will be appreciated that numerous modifications may be made to the embodiments described without departing from the scope of the invention. In particular, the system architecture, method steps and data flow as described may be conducted in any number of different ways and in any workable order.

The system and method of the invention provides a way of establishing a secure communication channel between a mobile handset, in particular a mobile phone, and a remotely accessible server such as an online application server, by ensuring that sensitive data such as data relating to financial transactions or access to a financial account is transmitted over a channel which is both symmetrically and asymmetrically encrypted.

The invention may provide a secure way of transacting from mobile phones with online application servers, thus making it possible and safe for service providers, such as banks, to allow the use of the full functionality of their online services from mobile phones and other mobile handsets.

The invention provides a handset software application configured to be installed on a mobile handset to receive a key transfer message and asymmetrically decrypt the key transfer message to obtain a symmetric key therefrom. This symmetric key is dynamic and changes each time a triggering event takes place.

A new symmetric key may therefore be calculated at the server for each new communication session or may change during a communication session, for example as a result of asymmetric encryption as described, without the mobile handset being exposed to the values used to calculate the symmetric key. In this way, even if a miscreant intercepts one such symmetric key, it may have already become unusable or may only be of use for a short period of time.

It is envisaged that, if the remotely accessible server establishes that a communicating party is attempting to reuse an old or previously used symmetric key, the remotely accessible server may block communications from a mobile handset of that party or otherwise restrict the communicating party from accessing an application or portal. The remotely accessible server may, for example, block or revoke a digital certificate associated with such a party or the mobile handset of the party.

The server may thus, in response to determining that the previously used symmetric key or a symmetric key used or generated prior to the previously used symmetric key was used to encrypt data received from the mobile handset instead of using the symmetric key generated using the updated counter value, associate the mobile handset with a potential security threat. Any suitable action may be taken before blocking or restricting the mobile handset or user associated with the potential security threat. The user may, for example, be required to enter a passcode or perform some form of out-of-band authentication. If authentication succeeds, the server may accept that there is no security threat and that the key transfer message containing the most recent symmetric key was simply not successfully transmitted to or obtained at the mobile handset, and may allow communications to continue normally.

It is also envisaged that the remotely accessible server or the entity controlling the remotely accessible server may not only store details such as the handset public key and the current or latest symmetric key, but also maintain a record of a plurality of previously used symmetric keys. For example, all of the symmetric keys generated and/or used over a period of one year in relation to a particular user or mobile handset may be stored by the remotely accessible server or the controlling entity.

Maintaining such records enables previous communications between a mobile handset and the remotely accessible server to be decrypted if necessary. This may be required, for example, by financial, banking or other security regulations. It should be appreciated that the actual symmetric keys themselves may not need to be stored, as the counter value may simply be reduced in order to recalculate previously used symmetric keys.

Whereas known methods of generating symmetric keys may involve both the mobile handset and the remotely accessible server being required to possess a seed value and/or a counter value at some stage, the present invention permits these values to be known only at the server, thereby possibly further reducing the risk that these values may be obtained and fraudulently used.

It should be appreciated that the invention extends to a computer program product for establishing a secure communication channel between a mobile handset and a remotely accessible server, the computer program product comprising a computer-readable medium having stored computer-readable program code for performing the steps of: deterministically updating a used counter value to yield an updated counter value, the used counter value having been used to generate a previously used symmetric key for encrypting communications between the remotely accessible server and the mobile handset; storing the updated counter value; using the updated counter value to generate a symmetric key; generating a key transfer message including the symmetric key generated using the updated counter value; asymmetrically encrypting the key transfer message using a handset public key associated with the mobile handset; transmitting the key transfer message to the mobile handset such that the mobile handset is capable of using a handset private key corresponding to the handset public key to decrypt the key transfer message and obtain the symmetric key; decrypting further data received from the mobile handset asymmetrically using a server private key associated with the remotely accessible server and symmetrically using the symmetric key; and encrypting further data communicated to the mobile handset symmetrically using the symmetric key and asymmetrically using the handset public key. The computer-readable medium may be a non-transitory computer-readable medium, the computer-readable program code being executable by a processing circuit.

The invention claimed is:

1. A method of establishing a secure communication channel between a mobile handset and a remotely accessible server, the method being carried out at the remotely accessible server and comprising the steps of:
deterministically updating a used counter value to yield an updated counter value, the used counter value having been used to generate a previously used symmetric key for encrypting communications between the remotely accessible server and the mobile handset;
storing the updated counter value;
using the updated counter value to generate a symmetric key;
generating a key transfer message including the symmetric key generated using the updated counter value;
asymmetrically encrypting the key transfer message using a handset public key associated with the mobile handset;
transmitting the key transfer message to the mobile handset such that the mobile handset is capable of using a handset private key corresponding to the handset public key to decrypt the key transfer message and obtain the symmetric key;
decrypting further data received from the mobile handset asymmetrically using a server private key associated with the remotely accessible server and symmetrically using the symmetric key; and
encrypting further data communicated to the mobile handset symmetrically using the symmetric key and asymmetrically using the handset public key.

2. The method as claimed in claim 1, wherein the step of deterministically updating the used counter value is triggered by one or both of a mobile handset initiation event and a server initiation event.

3. The method as claimed in claim 2, wherein the mobile handset initiation event or the server initiation event includes an asymmetric cryptographic operation performed on data communicated between the remotely accessible server and the mobile handset.

4. The method as claimed in claim 2, wherein the mobile handset initiation event includes one or both of: any communication transmitted from the mobile handset to the remotely accessible server, and any communication transmitted from the remotely accessible server to the mobile handset.

5. The method as claimed in claim 2, wherein the mobile handset initiation event includes one or more of: receiving a communication from the mobile handset which is encrypted asymmetrically using the server public key, receiving a communication from the mobile handset which is digitally signed using the handset private key, and receiving a communication from the mobile handset which is encrypted symmetrically using the previously used symmetric key.

6. The method as claimed in claim 2, wherein the server initiation event includes one or more of: one or more handshake steps between the remotely accessible server and the mobile handset, transmitting a communication to the mobile handset which is encrypted asymmetrically using the handset public key, and transmitting a communication to the mobile handset which is encrypted symmetrically using the previously used symmetric key.

7. The method as claimed in claim 1, wherein the step of deterministically updating the used counter value is triggered when a new communication session between the remotely accessible server and the mobile handset commences.

8. The method as claimed in claim 1, wherein the used counter value has been used together with a static seed value to generate the previously used symmetric key, and wherein the step of using the updated counter value to generate a symmetric key includes using the updated counter value together with the static seed value.

9. The method as claimed in claim 8, wherein both the counter value and the static seed value are unknown to the mobile handset.

10. The method as claimed in claim 8, wherein the symmetric key is generated using a one-time password algorithm, and wherein the counter value and the static seed value are respectively used as a counter and a key in the algorithm.

11. The method as claimed in claim 10, wherein the one-time password algorithm is Initiative For Open Authentication (OATH) HOTP.

12. The method as claimed in claim 1, further including at least one handshake step carried out between the remotely accessible server and the mobile handset, the at least one handshake step including one or both of:
receiving a digital user certificate from the mobile handset using a server software application installed on the remotely accessible server and validating the digital user certificate by utilizing functionality provided by an encryption module distributed by a certificate authority, the digital user certificate having been issued to the mobile handset by the certificate authority and including the handset public key and an identifier uniquely associated with the mobile handset; and
transmitting a digital server certificate to the mobile handset for validation of the remotely accessible server, validation of the digital server certificate being conducted using a handset software application installed on the mobile handset utilizing functionality provided by an encryption module provided by the certificate authority, the digital server certificate having been issued to the remotely accessible server by the certificate authority and including the server public key corresponding to the server private key.

13. The method as claimed in claim 2, wherein the key transfer message is either an acknowledgement message transmitted to the mobile handset in response to a mobile handset initiation event, or is transmitted to the mobile handset as part of an asymmetrically encrypted payload.

14. The method as claimed in claim 1, further including the step of: if symmetric decryption of further data using the symmetric key is unsuccessful, attempting to decrypt the further data using the previously used symmetric key generated using the used counter value instead of using the symmetric key generated using the updated counter value, thereby accounting for the possibility of the key transfer message not being successfully transmitted to or obtained at the mobile handset.

15. The method as claimed in claim 1, further including the step of: in response to determining that the previously used symmetric key or a symmetric key used or generated prior to the previously used symmetric key was used to encrypt data received from the mobile handset instead of using the symmetric key generated using the updated counter value, associating the mobile handset with a potential security threat.

16. A system for establishing a secure communication channel between a mobile handset and a remotely accessible server, the system comprising:
a handset software application configured to be installed on a mobile handset to receive a key transfer message and asymmetrically decrypt the key transfer message to obtain a symmetric key therefrom, the mobile handset having associated therewith a handset public key and a corresponding handset private key; and
a remotely accessible server including:
an asymmetric cryptographic component for performing asymmetric encryption and decryption;
a symmetric cryptographic component for performing symmetric encryption and decryption;
a counter updating component for deterministically updating a used counter value to yield an updated counter value, the used counter value having been used to generate a previously used symmetric key for encrypting communications between the remotely accessible server and the mobile handset;
a storing component for storing the updated counter value;
a key generating component for using the updated counter value to generate a symmetric key;
a message generating component for generating a key transfer message including the symmetric key generated using the updated counter value;
a data transmitting component for transmitting data to the mobile handset; and
a data receiving component for receiving data from the mobile handset, wherein the remotely accessible server is configured to: asymmetrically encrypt the key transfer message using the handset public key; transmit the key transfer message to the mobile handset such that the mobile handset is capable of using the handset private key corresponding to the handset public key to decrypt the key transfer message and obtain the symmetric key; decrypt further data received from the mobile handset asymmetrically using a server private key associated with the remotely accessible server and symmetrically using the symmetric key; and encrypt further data communicated to the mobile handset symmetrically using the symmetric key and asymmetrically using the handset public key.

17. The system as claimed in claim 16, wherein the remotely accessible server further includes a triggering component for triggering deterministic updating of a used counter value, deterministic updating of a used counter value being triggered by one or both of a mobile handset initiation event and a server initiation event.

18. The system as claimed in claim 16, wherein the handset software application further includes a server validation component for validating a digital server certificate transmitted from the remotely accessible server to the mobile handset, validation of the digital server certificate being conducted utilizing functionality provided by an encryption module provided by a certificate authority, the digital server certificate having been issued to the remotely accessible server by the certificate authority and including the server public key corresponding to the server private key.

19. The system as claimed in claim 16, wherein the remotely accessible server further includes a handset validation component for validating a digital user certificate transmitted from the mobile handset to the remotely accessible server, validation of the digital user certificate being conducted utilizing functionality provided by an encryption module distributed by a certificate authority, the digital user certificate having been issued to the mobile handset by the certificate authority and including the handset public key and an identifier uniquely associated with the mobile handset.

20. A computer program product for establishing a secure communication channel between a mobile handset and a remotely accessible server, the computer program product comprising a computer-readable medium having stored computer-readable program code for performing the steps of:
deterministically updating a used counter value to yield an updated counter value, the used counter value having been used to generate a previously used symmetric key for encrypting communications between the remotely accessible server and the mobile handset;
storing the updated counter value;
using the updated counter value to generate a symmetric key;
generating a key transfer message including the symmetric key generated using the updated counter value;
asymmetrically encrypting the key transfer message using a handset public key associated with the mobile handset;
transmitting the key transfer message to the mobile handset such that the mobile handset is capable of using a handset private key corresponding to the handset public key to decrypt the key transfer message and obtain the symmetric key;
decrypting further data received from the mobile handset asymmetrically using a server private key associated with the remotely accessible server and symmetrically using the symmetric key; and
encrypting further data communicated to the mobile handset symmetrically using the symmetric key and asymmetrically using the handset public key, wherein the computer-readable medium is a non-transitory computer-readable medium, the computer-readable program code being executable by a processing circuit.
